(19) United States
(12) Patent Application Publication
(10) Pub. No.: US 2008/0057279 A1
(43) Pub. Date: Mar. 6, 2008

(54) LAMINATED HEAT-TRANSFER INTERFACE FOR COOLER MODULE

(75) Inventor: Chih-Liang Fang, Hsintien City (TW)

Correspondence Address: ADLINK TECHNOLOGY INC., P.O. BOX 108-00403, TAIPEI, omitted

(73) Assignee: ADLINK TECHNOLOGY INC., Chungho City (TW)

(21) Appl. No.: 11/469,478

(22) Filed: Aug. 31, 2006

(51) Int. Cl. B32B 7/02

(52) U.S. Cl. 428/212

(57) ABSTRACT

A laminated heat-transfer interface used in a cooler module to dissipate heat from heat generating devices of a circuit board is disclosed to include a heat plate affixed to the circuit board, first heat-transfer sheet members of high Kelvin value and low heat resistance material respectively attached to the heat generating devices of the circuit board, second heat-transfer sheet members of elastically deformable low Kelvin value and high heat resistance material having the characteristic of transferring heat energy in vertical direction respectively bonded to the heat plate, and flat heat-transfer blocks having the characteristic of transferring heat energy evenly in horizontal direction and vertical direction respectively sandwiched between the first heat-transfer sheet members and the second heat-transfer sheet members.

### BACKGROUND OF THE INVENTION

1. Field of the Invention

The present invention relates to cooler modules and more particularly, to a laminated heat-transfer interface for cooler module, which is attachable to different heat generating devices of different heights on a circuit board to effectively dissipate heat from the heat generating devices by means of first heat-transfer sheet members of high Kelvin value and low heat resistance, flat heat-transfer blocks, and second heat-transfer sheet members of low Kelvin value and high heat resistance.

2. Description of the Related Art

Advanced electronic devices commonly have a high-density design and light, thin, short and small characteristics. These electronic devices require much power and generate much heat during working. Therefore, high-performance heat sinks are commonly used to dissipate heat from advanced electronic devices. A high-performance heat sink has a broad base area and a relatively greater heat-dissipation surface area. Changing the length, height, thickness and pitch of radiation fins may relatively improve the heat dissipation performance of the heat sink. Further, the mounting stability between the heat sink and the circuit board also affect heat dissipation efficiency. Further, a circuit board (motherboard) for industrial computer has installed therein a plurality of chips and different types of microprocessors. Different types of microprocessors have different operational functions, different thicknesses, different heights, and different dimensions. Because the microprocessors and chips of a circuit board for industrial computer have different heights, it is complicated to install heat sinks in a circuit board for industrial computer and to keep installed heat sinks in positive contact with the chips and/or microprocessors of the circuit board.

Further, heat-transfer devices (heat pipes) and cooling fans may be used with heat sinks to dissipate heat from the chips and microprocessors of a circuit board for industrial computer. Further, regular heat sinks are commonly made out of aluminum or copper, having a flat contact surface for contacting chips and/or microprocessors. When bonding a heat sink to a circuit board, a tin solder or the like shall be used. Further, after bonding of a heat sink to a circuit board, the flat contact surface of the heat sink may be not positively kept in close contact with all chips and/or microprocessors, resulting in low dissipation efficiency. If a thick, deformable, heat-transfer plate of low heat-transfer coefficient is used, it can be kept in close contact with chips and microprocessors of different heights. However, a heat-transfer plate of this design has low dissipation efficiency.

### SUMMARY OF THE INVENTION

The present invention has been accomplished under the circumstances in view. According to one aspect of the present invention, the laminated heat-transfer interface is fastened to a circuit board having a plurality of heat generating devices and adapted to carry heat away from the heat generating device. The laminated heat-transfer interface comprises a heat plate fastened to one side of the circuit board and facing the heat generating devices; a plurality of first heat-transfer sheet members made out of a high Kelvin value and low heat resistance material and respectively attached to the heat generating devices of the circuit board; a plurality of second heat-transfer sheet members made out of a high Kelvin value and low heat resistance material having the characteristic of transferring heat energy in vertical direction, the second heat-transfer sheet members being respectively bonded to the heat plate at locations corresponding to the heat generating devices of the circuit board, the second heat-transfer sheet members having a thickness greater than the first heat-transfer sheet members; and a plurality of flat heat-transfer blocks respectively sandwiched between the first heat-transfer sheet members and the second heat-transfer sheet members, the flat heat-transfer blocks having the characteristic of transferring heat energy evenly in horizontal direction and vertical direction.

According to another aspect of the present invention, the second heat-transfer sheet members are elastically deformable so that the second heat-transfer sheet members are differently deformed to compensate for the elevation differences among the heat generating devices after fastening of the laminated heat-transfer interface to the circuit board.

### BRIEF DESCRIPTION OF THE DRAWINGS

FIG. 1 is an exploded view of a laminated heat-transfer interface according to the present invention.

FIG. 2 illustrates the outer appearance of the laminated heat-transfer interface and the relationship between the laminated heat-transfer interface and the heat generating devices on the circuit board according to the present invention.

FIG. 3 is a sectional view showing installation of the circuit board and the laminated heat-transfer interface according to the present invention (I).

FIG. 4 is a sectional view showing installation of the circuit board and the laminated heat-transfer interface according to the present invention (II).

### DETAILED DESCRIPTION OF THE PREFERRED EMBODIMENT

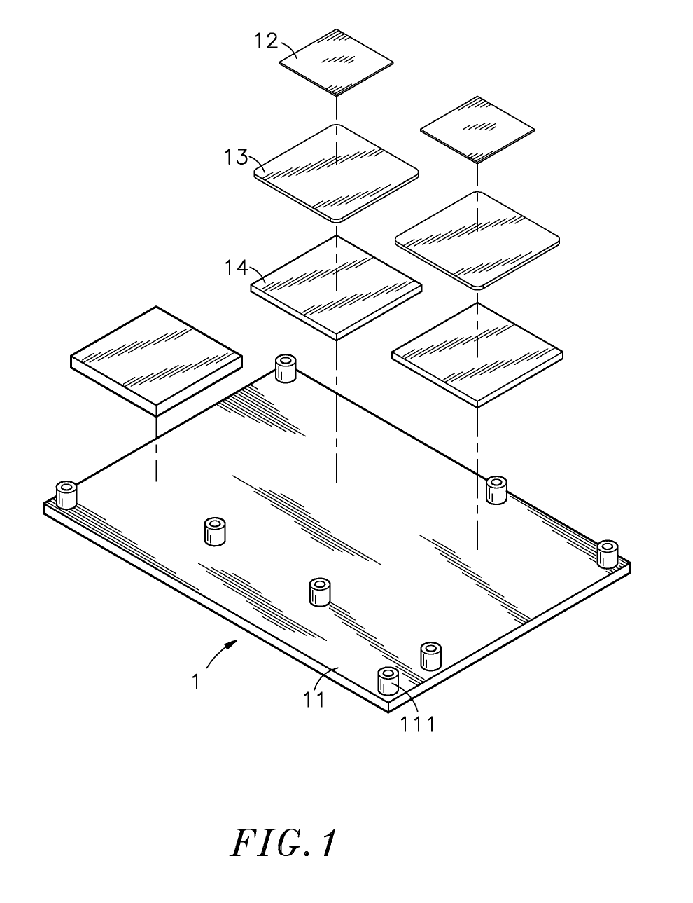

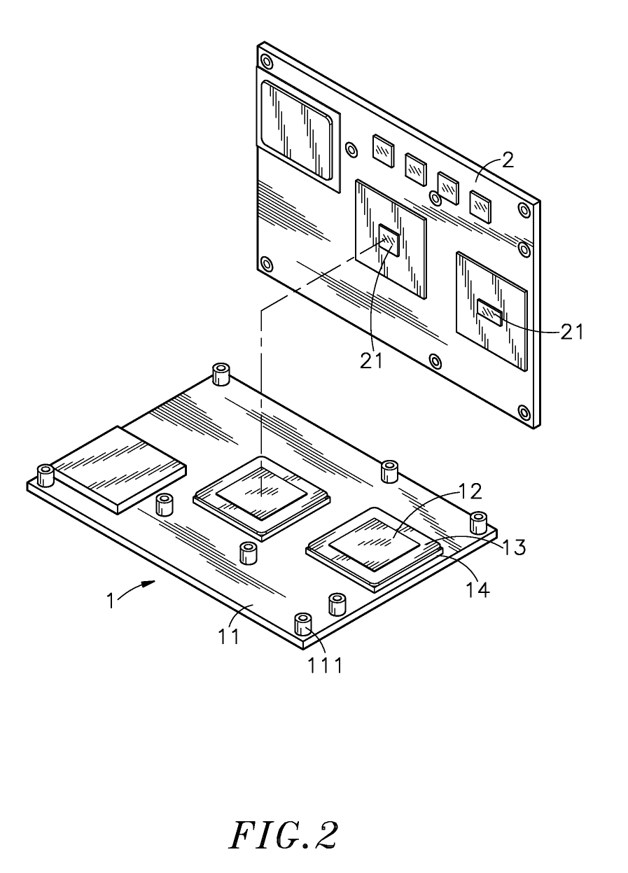

Referring to FIGS. 1 and 2, a laminated heat-transfer interface 1 in accordance with the present invention is shown comprised of a heat plate 11, a plurality of first heat-transfer sheet members 12, a plurality of flat heat-transfer blocks 13, and a plurality of second heat-transfer sheet members 14.

The heat plate 11 is a flat metal plate made out of aluminum, copper, or any of a variety of other metal materials, having the characteristic of transferring heat energy evenly in horizontal direction as well as vertical direction. The heat plate 11 has a plurality of raised mounting holes 111 on the top side thereof.

The flat heat-transfer blocks 13 are respectively sandwiched between the first heat-transfer sheet members 12 and the second heat-transfer sheet members 14. The second heat-transfer sheet members 14 are respectively bonded to the top surface of the heat plate 11.

The first heat-transfer sheet members 12 are made out of a material of high Kelvin value and low heat resistance. The first heat-transfer sheet members 12 have a thickness within 0.2˜0.3 mm. The Kelvin value of the first heat-transfer sheet members 12 is preferably within 10˜18 w/mk° F.

The flat heat-transfer blocks 13 each have a bottom surface respectively bonded to the second heat-transfer sheet members 14 and a top surface respectively bonded to the first heat-transfer sheet members 12. Further, the flat heat-transfer blocks 13 each have a cross sectional area greater than the first heat-transfer sheet members 12. The flat heat-transfer blocks 13 are made out of aluminum, copper, or any of a variety of other metal materials having the characteristic of transferring heat energy evenly in horizontal direction as well as vertical direction.

The second heat-transfer sheet members 14 are respectively sandwiched between the heat plate 11 and the flat heat-transfer blocks 13. The second heat-transfer sheet members 14 are made out of a material that has a low Kelvin value and high heat resistance and the characteristic of transferring heat energy in vertical direction. The second heat-transfer sheet members 14 have a cross sectional area equal to the flat heat-transfer blocks 13. Further, the second heat-transfer sheet members 14 have a thickness within about 0.8˜4 mm. The Kelvin value of the second heat-transfer sheet members 14 is within about 1˜6 w/mk° F.

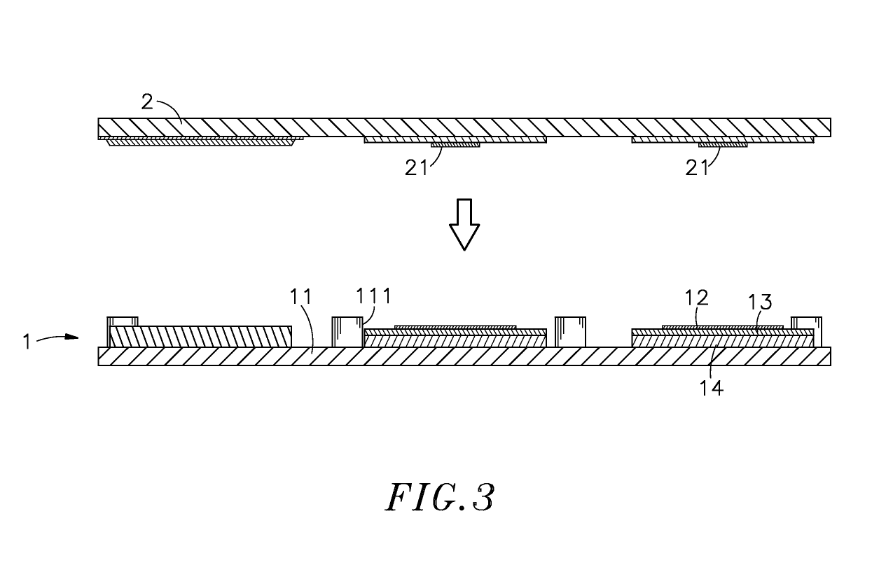

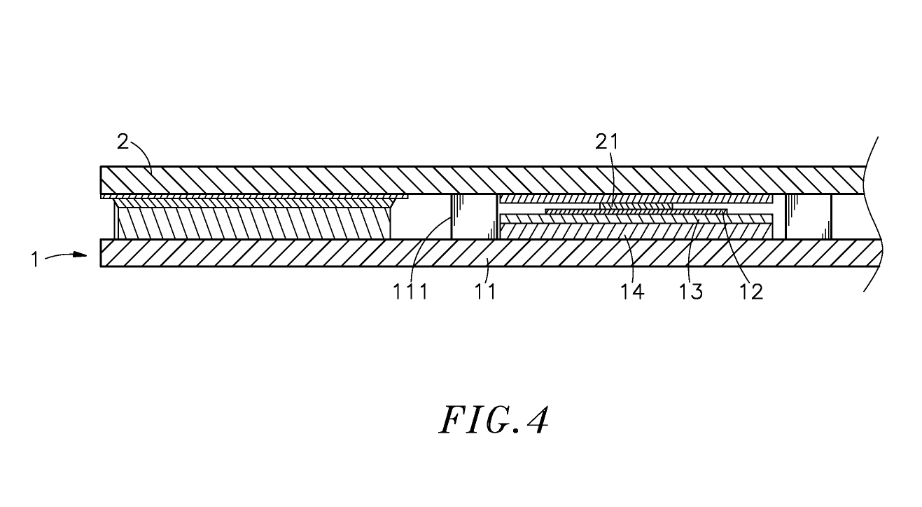

Referring to FIGS. 3 and 4 and FIGS. 1 and 2 again, the first heat-transfer sheet members 12 are respectively bonded to the top surfaces of the flat heat-transfer blocks 13, and then the bottom surfaces of the flat heat-transfer blocks 13 are respectively bonded to the top surfaces of the second heat-transfer sheet members 14, and then the bottom surfaces of the second heat-transfer sheet members 14 are respectively bonded to the top surface of the heat plate 11 subject to the locations of heat generating devices 21 on a circuit board 2 (see FIG. 2), and then the circuit board 2 is affixed to the raised mounting holes 111 of the heat plate 11 with fastening members, for example, screws (not shown), keeping the heat generating devices 21 of the circuit board 2 is close contact with the first heat-transfer sheet members 12 (see FIG. 4). After installation, the second heat-transfer sheet members 14 are deformed to compensate for elevation differences among the heat generating devices 21 of the circuit board 2, the first heat-transfer sheet members 12 in positive contact with the heat generating devices 21.

Further, when the circuit board 2 and the laminated heat-transfer interface 1 are assembled, the heat plate 11 can be bonded to a metal shell for enabling heat energy to be transferred from the heat generating devices 21 to the outside of the metal shell by the laminated heat-transfer interface 1. Alternatively, a cooling fan can be used to cause currents of air toward the laminated heat-transfer interface 1, thereby carrying heat away from the laminated heat-transfer interface 1.

Further, the aforesaid heat generating devices 21 can be IC chips, microprocessors, electronic transistors, semiconductor devices, or other electronic components that generate heat during operation.

As stated above, the laminated heat-transfer interface of the present invention has the follow benefits:
1. The first heat-transfer sheet members 12 of high Kelvin value and low heat resistance are directly attached to the heat generating devices 21 to transfer heat energy vertically from the heat generating devices 21 to the flat heat-transfer blocks 13, which distributes heat energy in vertical direction as well as in horizontal direction. Therefore, heat energy is further transferred from the flat heat-transfer blocks 13 to the elastically deformable second heat-transfer sheet members 14 of low Kelvin value and high heat resistance and then the heat plate 11 for further dissipation.
2. By means of the rapid and vertical heat transfer characteristic of the first heat-transfer sheet members 12 and the horizontal and vertical heat transfer characteristic of the flat heat-transfer blocks 13, heat energy is quickly transferred from the heat generating devices 21 to the second heat-transfer sheet members 14 and then the heat plate 11 for further dissipation, preventing accumulation of heat energy at the heat generating devices 21.
3. Because the second heat-transfer sheet members 14 are elastically deformed to provide a shock absorbing and buffering effect when the first heat-transfer sheet members 12 are attached to the heat generating devices 21, the laminated heat-transfer interface 1 does not cause a concentration of stress at the heat generating devices 21.
4. When the laminated heat-transfer interface 1 and the circuit board 2 are fastened together, the first heat-transfer sheet members 12 are kept in close contact with the heat generating devices 21, and the second heat-transfer sheet members 14 are differently compressed to compensate for high differences among the heat generating devices 21. Therefore, one single laminated heat-transfer interface 1 is workable to dissipate heat from all the heat generating devices 21 of the circuit board 2.
5. The laminated heat-transfer interface 1 is designed subject to the arrangement of the heat generating devices 21 of the circuit board 2. The thickness of the second heat-transfer sheet members 14 is determined subject to the maximum height difference among the heat generating devices 21. Further, the first heat-transfer sheet members 12, the flat heat-transfer blocks 13 and the second heat-transfer sheet members 14 can be respectively fastened together by bonding.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A laminated heat-transfer interface fastened to a circuit board having a plurality of heat generating devices for carrying heat away from said heat generating devices, the laminated heat-transfer interface comprising:
a heat plate fastened to one side of said circuit board and facing said heat generating devices;
a plurality of first heat-transfer sheet members made out of a high Kelvin value and low heat resistance material and respectively attached to said heat generating devices of said circuit board;
a plurality of second heat-transfer sheet members made out of an elastically deformable material having a low Kelvin value and high heat resistance and the characteristic of transferring heat energy in vertical direction, said second heat-transfer sheet members being respectively bonded to said heat plate at locations corresponding to said heat generating devices of said circuit board, said second heat-transfer sheet members having a thickness greater than said first heat-transfer sheet members; and
a plurality of flat heat-transfer blocks respectively sandwiched between said first heat-transfer sheet members and said second heat-transfer sheet members, said flat heat-transfer blocks having the characteristic of transferring heat energy evenly in horizontal direction and vertical direction.

2. The laminated heat-transfer interface as claimed in claim 1, wherein said first heat-transfer sheet members have a thickness within 0.2˜0.3 mm.

3. The laminated heat-transfer interface as claimed in claim 1, wherein said first heat-transfer sheet members have a Kelvin value within 10˜18 w/mk° F.

4. The laminated heat-transfer interface as claimed in claim 1, wherein said second heat-transfer sheet members have a thickness within 0.8˜4 mm.

5. The laminated heat-transfer interface as claimed in claim 1, wherein said second heat-transfer sheet members have a Kelvin value within 1˜6 w/mk° F.

6. The laminated heat-transfer interface as claimed in claim 1, wherein said flat heat-transfer blocks have a cross sectional area greater than said first heat-transfer sheet members, and are made out of aluminum.

7. The laminated heat-transfer interface as claimed in claim 1, wherein said flat heat-transfer blocks have a cross sectional area greater than said first heat-transfer sheet members, and are made out of copper.

8. The laminated heat-transfer interface as claimed in claim 1, wherein said flat heat-transfer blocks have a cross sectional area equal to said second heat-transfer sheet members.

9. The laminated heat-transfer interface as claimed in claim 1, wherein said heat plate is made out of aluminum.

10. The laminated heat-transfer interface as claimed in claim 1, wherein said heat plate is made out of copper.

11. The laminated heat-transfer interface as claimed in claim 1, wherein said heat plate has a plurality of mounting holes respectively fastened to respective mounting holes of said circuit board.

12. The laminated heat-transfer interface as claimed in claim 1, wherein said heat plate is bonded to an external metal shell.

13. The laminated heat-transfer interface as claimed in claim 1, wherein said heat plate is used with a fan that causes currents of air toward said heat plate to carry heat away from said heat plate.

14. The laminated heat-transfer interface as claimed in claim 1, wherein said heat generating devices include at least one IC chip.

15. The laminated heat-transfer interface as claimed in claim 1, wherein said heat generating devices include at least one microprocessor.

16. The laminated heat-transfer interface as claimed in claim 1, wherein said heat generating devices include at least one semiconductor device.

17. The laminated heat-transfer interface as claimed in claim 1, wherein said heat generating devices include at least one electronic transistors.
